(19) United States
(12) Patent Application Publication
(10) Pub. No.: US 2015/0044654 A1
(43) Pub. Date: Feb. 12, 2015

(54) Crowd-Sourced Assessment of Technical Skill (C-SATS™/CSATS™)

(71) Applicant: University of Washington Through its Center for Commercialization, Seattle, WA (US)

(72) Inventors: Thomas Lendvay, Seattle, WA (US); Carolyn Chen, Seattle, WA (US); Timothy Mariusz Kowalewski, Minneapolis, MN (US); Lee W. White, Stanford, CA (US)

(21) Appl. No.: 14/455,764

(22) Filed: Aug. 8, 2014

Related U.S. Application Data
(60) Provisional application No. 61/864,071, filed on Aug. 9, 2013.

(51) Int. Cl. G09B 7/02; G09B 23/28

(52) U.S. Cl. CPC G09B 7/02; G09B 23/28
USPC 434/262

(57) ABSTRACT

Methods and apparatus are provided for evaluating surgical skills. A computing device can receive a request to evaluate media content of surgical skills with an evaluation form for evaluating the surgical skills. The computing device can determine evaluator groups. The computing device can provide the media content and the evaluation form to each evaluator group. The computing device can receive evaluations of the surgical skills from at least one evaluator of each evaluator group. Each evaluation can include at least one partially-completed evaluation form. The computing device can determine, for each evaluator group, one or more per-group scores of the surgical skills, where the per-group scores for a designated evaluation group are based on an analysis of the evaluations of the surgical skills from the evaluators in the designated evaluation group. The computing device can provide the one or more per-group scores.

### CROSS-REFERENCE TO RELATED APPLICATIONS

The present application claims priority to U.S. Provisional Patent Application No. 61/864,071 entitled “Crowd-Sourced Assessment of Technical Skill (C-SATS™)”, filed Aug. 9, 2013, which is entirely incorporated by reference herein for all purposes.

### BACKGROUND

Unless otherwise indicated herein, the materials described in this section are not prior art to the claims in this application and are not admitted to be prior art by inclusion in this section.

The annual mortality due to medical errors may be as high as 98,000 patients in the United States. Even more patients experience morbidity yielding consequences both clinically and economically. An extra 2.4 million hospital days and $9.3 billion are incurred annually due to medical errors.

Efforts to reduce surgical complication rates have included incorporation of simulation training for learning and re-certification of surgical skills. Global surgical performance-rating scales like the Objective Structured Assessment of Technical Skills (OSATS) have been widely adopted for assessment of surgical skill and the determination of trainee advancement. These methods, although validated, are time-intensive and rely on real-time or video-recorded analysis by surgical experts who first need to demonstrate inter-rater reliability

### SUMMARY

In one aspect, a method is provided. A computing device receives a request to evaluate media content related to one or more surgical skills and an evaluation form for evaluating the one or more surgical skills. The computing device determines a plurality of evaluator groups to evaluate the one or more surgical skills. The computing device provides the media content and the evaluation form to each evaluator group of the plurality of evaluator groups. Each evaluator group includes one or more evaluators. The computing device receives evaluations of the one or more surgical skills from at least one evaluator of each of the plurality of evaluator groups. Each of the evaluations includes an at least partially-completed evaluation form. The computing device determines, for each evaluator group of the plurality of evaluator groups, one or more per-group scores of the one or more surgical skills. The one or more per-group scores for a designated evaluation group are based on an analysis of the evaluations of the one or more surgical skills from the evaluators in the designated evaluation group. The computing device provides at least one score of the one or more per-group scores of the one or more surgical skills.

In another aspect, a computing device is provided. The computing device includes a processor and a non-transitory tangible computer readable medium. The non-transitory tangible computer readable medium is configured to store at least executable instructions. The executable instructions, when executed by the processor, cause the computing device to perform functions. The functions include: receiving a request to evaluate media content related to one or more surgical skills and an evaluation form for evaluating the one or more surgical skills; determining a plurality of evaluator groups to evaluate the one or more surgical skills; providing the media content and the evaluation form to each evaluator group of the plurality of evaluator groups, where each evaluator group includes one or more evaluators; receiving evaluations of the one or more surgical skills from at least one evaluator of each of the plurality of evaluator groups, where each of the evaluations includes an at least partially-completed evaluation form; determining, for each evaluator group of the plurality of evaluator groups, one or more per-group scores of the one or more surgical skills, where the one or more per-group scores for a designated evaluation group are based on an analysis of the evaluations of the one or more surgical skills from the evaluators in the designated evaluation group, and providing at least one score of the one or more per-group scores of the one or more surgical skills.

In another aspect, a non-transitory tangible computer readable medium is provided. The tangible computer readable medium is configured to store at least executable instructions. The executable instructions, when executed by a processor of a computing device, cause the computing device to perform functions. The functions include: receiving a request to evaluate media content related to one or more surgical skills and an evaluation form for evaluating the one or more surgical skills; determining a plurality of evaluator groups to evaluate the one or more surgical skills; providing the media content and the evaluation form to each evaluator group of the plurality of evaluator groups, where each evaluator group includes one or more evaluators; receiving evaluations of the one or more surgical skills from at least one evaluator of each of the plurality of evaluator groups, where each of the evaluations includes an at least partially-completed evaluation form; determining, for each evaluator group of the plurality of evaluator groups, one or more per-group scores of the one or more surgical skills, where the one or more per-group scores for a designated evaluation group are based on an analysis of the evaluations of the one or more surgical skills from the evaluators in the designated evaluation group; and providing at least one score of the one or more per-group scores of the one or more surgical skills.

In another aspect, a computing device is provided. The computing device includes processing means; means for receiving a request to evaluate media content related to one or more surgical skills and an evaluation form for evaluating the one or more surgical skills; means for determining a plurality of evaluator groups to evaluate the one or more surgical skills; means for providing the media content and the evaluation form to each evaluator group of the plurality of evaluator groups, where each evaluator group includes one or more evaluators; means for receiving evaluations of the one or more surgical skills from at least one evaluator of each of the plurality of evaluator groups, where each of the evaluations includes an at least partially-completed evaluation form; means for determining, for each evaluator group of the plurality of evaluator groups, one or more per-group scores of the one or more surgical skills, where the one or more per-group scores for a designated evaluation group are based on an analysis of the evaluations of the one or more surgical skills from the evaluators in the designated evaluation group; and means for providing at least one score of the one or more per-group scores of the one or more surgical skills.

### BRIEF DESCRIPTION OF THE DRAWINGS

FIG. 1 shows a scenario for evaluation of media content by three evaluation groups using the C-SATS™/CSATS™ system, in accordance with an embodiment.

FIG. 2A is a graph of crowd-surgeon coefficients, including a best-fit line, for a rocking pegboard task, in accordance with an embodiment.

FIG. 2B is a graph of crowd-surgeon coefficients, including a best-fit line, for a suturing task, in accordance with an embodiment.

FIGS. 3A and 3B are respective graphs of C-SATS™/CSATS™ scores for the rocking pegboard task and the suturing task, each graph representing data with and without warm-up for the respective task, in accordance with an embodiment.

FIG. 4 depicts an example evaluation form, in accordance with an embodiment.

FIG. 5 exhibits images from a block transfer task side-by-side video used to screen subjects, in accordance with an embodiment.

FIG. 6 exhibits an image from media content graded by evaluation groups, in accordance with an embodiment.

FIG. 7 is a word analysis diagram, in accordance with an embodiment.

FIG. 8 depicts three inclusion/exclusion diagrams, in accordance with an embodiment.

FIG. 9 is a composite graph of scoring density from three evaluation groups, in accordance with an embodiment.

FIG. 10 is a plot of evaluation group participation over time, in accordance with an embodiment.

FIG. 11 is a graph of scoring density based on evaluator's free-text use or non-use of negation words from three evaluation groups, in accordance with an embodiment.

FIG. 12 is a block diagram of an example computing network, in accordance with an embodiment.

FIG. 13A is a block diagram of an example computing device, in accordance with an embodiment.

FIG. 13B depicts an example cloud-based server system, in accordance with an embodiment.

FIG. 14 is a flow chart of an example method, in accordance with an embodiment.

### DETAILED DESCRIPTION

### Crowd-Sourced Assessment of Technical Skill (C-SATS™/CSATS™)

A Crowd-Sourced Assessment of Technical Skill (C-SATS™ or CSATS™, abbreviated herein as C-SATS™/CSATS™) system can manage crowd-sourcing activities related to evaluating media content. Crowd-sourcing is a relatively recent trend that uses an anonymous crowd to complete small, well-defined tasks. Ongoing research in the area investigates how to define tasks in a way that enable the crowd to accomplish complex and/or expert-level work. Various workflows can be used to break a complex piece of work into approachable parts and can also use the crowd to check the quality of its own work. Crowd-sourcing has been used to help blind mobile phone users navigate their environment, decipher complex protein folding structures with the online game called Foldit, and solve medical cases through the website CrowdMed.com. In particular, crowds of untrained people on the Internet can provide assessment of dry lab robotic surgical performances very similar to assessments provided by trained surgeons using the C-SATS™/CSATS™ system described herein.

For example, the C-SATS™/CSATS™ system can receive a request to evaluate media content, such as text, software, audio, and/or video content. Along with the media content, the request to evaluate media content can include an evaluation form and/or other documentation for rating certain aspects of the media content, and information to help evaluators properly evaluate a surgical procedure and/or related skills in the media content.

The request to evaluate media content can also include criteria related to selecting evaluators for one or more evaluator groups. In some cases, an evaluation group can be made up of evaluators with specific attributes, such as, but not limited to experts having a particular skill or training. In other cases, specific sources for evaluators can be provided as part of the criteria related to selecting evaluators; e.g., evaluators using a particular web-site, or evaluators living or working in a certain community. Upon receiving the request to evaluate media content, the C-SATS™/CSATS™ system can obtain evaluators for the requested evaluation groups, provide media content and information for evaluating the media content to the evaluators, receive evaluations from the evaluators, and generate assessment(s) of the evaluations.

One limitation of expert-group evaluation of media content is the potential for bias. Expert-group evaluation may be performed in-person and it is difficult to blind evaluators to the identity of the subject. Furthermore, blinded or not, expert evaluators may share commonalities with those being evaluated; e.g., share a teacher-student relationship or be part of the same professional groups. The crowd-sourced method can include double-blind techniques, where each reviewer is blind to the identity of the reviewee or reviewees in the video and each reviewer is also blind to the past or present ratings of other reviewers. Thus the ratings can be more objective. Further, crowd-sourced assessment can be time-efficient, as a crowd may be recruited and evaluate media content faster than an expert group.

Crowds can be recruited using crowd-sourcing services and social media. An example crowd-sourcing service is the Mechanical Turk™ by Amazon.com Inc. of Seattle, Wash. Other social media, such as, but not limited to, university websites and/or the Facebook™ website provided by Facebook™, Inc. of Menlo Park, Calif. can be utilized to carry out similar crowd-sourcing communications to request a task be completed by a number of people. In response to the request, the requester can receive task-completion results, which can be evaluated and perhaps rewarded; e.g., reward reviewers based on performance as reviewers.

In one example, the C-SATS™/CSATS™ system can be used for assessing surgical performance in a clinically-valid, inexpensive, and quick fashion. In one study of evaluating exhibiting a wide variety of skill levels, a crowd-provided C-SATS™/CSATS™ score can agree with scores provided by trained surgeon graders.

In this context, suppose a request to evaluate media content included: media content related to a surgical procedure, a request for two groups of evaluators: an expert group of at least 10 medical personnel who had performed at least 10 surgeries, and a non-expert group of at least 500 people. In this example, the C-SATS™/CSATS™ system can generate two sets of requests: one set of requests to at least 10 known experts for the expert group, such as surgeons, other medical doctors, and/or nurses, to evaluate the media content, and a second set of requests to 500 people to evaluate the media content as the non-expert group. As responses are received from each group of evaluators, the results can be tabulated and compared by the C-SATS™/CSATS™ system. Once each group has completed its evaluations, and perhaps at checkpoints during the evaluation process, a report can be generated with the resulting evaluation data, statistics, and comparisons between groups.

The C-SATS™/CSATS™ system can provide a fast, cheap, and less biased method of evaluating media content. For example, the C-SATS™/CSATS™ system can be used to evaluate objective media content, such as media content related to technical skill, and could provide initial categorization of skills among trainees and provide re-evaluation of skills of experienced personnel for maintenance of certification. The C-SATS™/CSATS™ system can be utilized within discrete elements of procedural education that can be out-sourced to ensure objectivity and efficiency. That is, the C-SATS™/CSATS™ system can help identify training deficiencies at various stages during a person's career; e.g., if the C-SATS™/CSATS™ system identifies deficiencies, then additional focused training can be initiated. Also, crowds can rate technical skills related to most, if not all, medical procedures anywhere in the world. One can envision procedural training in remote centers globally that use on-line crowd-sourcing to rapidly objectively quantify and perhaps qualify performance so that skills evaluation need not be on the ground. Furthermore, methods of evaluating surgical performance can use crowds for real-time intra-operative feedback, and so may improve performance and patient outcomes.

Additionally, by using both non-expert and expert groups to evaluate objective content, and comparing results between the groups, biases from each group can be detected, corrected as necessary, and reported. For example, if one evaluation group shows a bias in comparison to other evaluation groups, that bias can be reported or otherwise identified. If the bias is correctable; e.g., by scaling, re-centering, or otherwise mathematically adjusting the biased data in a consistent fashion, then the bias can be corrected. In some cases, corrected data can be provided with un-corrected data to give a requestor an opportunity to evaluate all data available to the C-SATS™/CSATS™ system. Many other types of media content can be evaluated as well.

### Example C-SATS™/CSATS™ System Usage Scenario

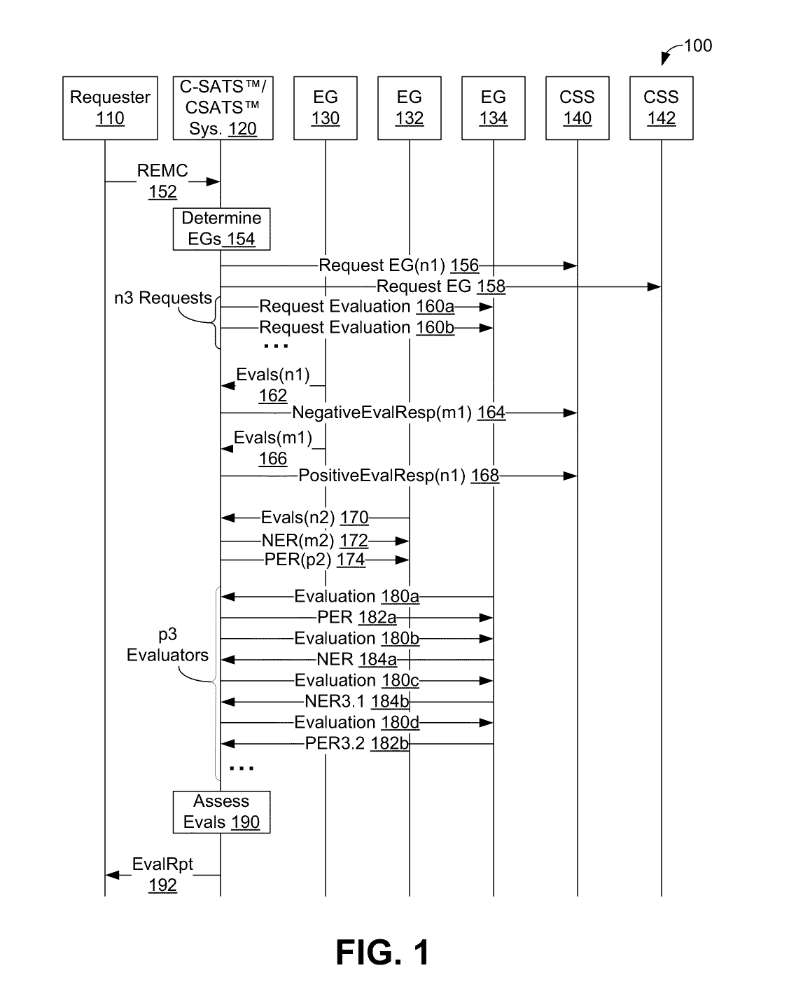

FIG. 1 shows scenario 100 for evaluation of media content by three evaluation groups using C-SATS™/CSATS™ system 120, in accordance with an embodiment. In scenario 100, requestor 110 send request to evaluate media content (REMC) 152 to C-SATS™/CSATS™ system 120. Request to evaluate media content 152 can include media content for evaluation, such as text, software, audio, and/or video content and information for evaluating the media content. In some embodiments, request to evaluate media content 152 can include a reference to the media content; e.g., a Uniform Resource Locator (URL), Uniform Resource Identifier (URI), Internet Protocol (IP) address, physical address and time(s) for observing media content, or other reference(s) that refer to the media content to be evaluated.

Request to evaluate media content 152 can include information about evaluating the media content. The information about evaluating the media content can include, but is not limited to, written and/or electronic evaluation forms(s), documentation, and/or other information related to the media content. For example, an evaluation form, perhaps provided as a web page, can be used to rate aspects of the media content. In some cases the evaluation form can include questions and/or other indicia to evaluate the evaluator; e.g., one or more questions about the media content to determine whether a member of the crowd correctly observed the media content as part of the evaluation. Other information can include, but is not limited to, instructions related to evaluating the media content, (background) information about the media content, scheduling/timing information, evaluator reward/payment information, non-disclosure of media content agreements, and media content identification information.

Request to evaluate media content 152 can also include criteria related to selecting evaluators for one or more evaluator groups. Example criteria include, but are not limited to, a number of evaluation groups, a number of evaluators per group, desired/required attributes of evaluators in a particular group, sources of evaluators, time limits for responses, and rewards for evaluators. In some cases, an evaluation group can be made up of evaluators with specific attributes, such as, but not limited to experts having a particular skill or training (e.g., surgeons, lawyers), geographical attributes (e.g., home location, work location, vacation destination), demographic attributes, financially-related attributes, and evaluators having a given affiliation, such as university-related affiliations, professional affiliations (e.g., American Medical Association, American Bar Association), interest affiliation (e.g., affiliation with an activity, sports team, hobby, artworks), and/or other affiliation. In other cases, specific sources for evaluators can be provided as part of the criteria related to selecting evaluators, such as evaluators recruited using the Mechanical Turk™ service, evaluators that use a particular social web-site, evaluators and evaluators employed by/associated with a company, other commercial organization, or non-profit organization. In some embodiments, request for evaluating media content 152 can have additional, other, or different information.

A requestor user interface to C-SATS™/CSATS™ system 120 can allow requestor 110 to provide the media content and/or reference(s) to the media content for evaluation, information about evaluating the media content, and criteria related to selecting evaluators for one or more evaluator groups to C-SATS™/CSATS™ system 120; i.e., a user interface to generate request for evaluating media content 152. In some embodiments, the requestor user interface to C-SATS™/CSATS™ system 120 can enable requestor 110 to review progress and/or output from C-SATS™/CSATS™ system 120; e.g., evaluation report 192.

In some embodiments, C-SATS™/CSATS™ system 120 can include an “evaluation group selection wizard” associated with the requestor user interface. The wizard can guide a requestor in selecting an evaluation group based on criteria such as size of the evaluation group, mean time to respond, costs/rewards, and desired attributes of the evaluators. For example, the wizard can compare crowd-sourcing services and other evaluation groups by a number of criteria, such as, but not limited to, mean response times, aggregate costs, per-evaluator costs, counts of available recruits, and provide recommendations on one or more evaluator groups that can be used to evaluate media content associated with request for evaluating media content 152

After receiving request for evaluating media content 152, C-SATS™/CSATS™ system 120 can determine evaluation groups (EGs) at block 154. In scenario 100, request for evaluating media content 152 included a request for three evaluation groups to evaluate media content MC: two groups of non-expert evaluators, shown in FIG. 1 as evaluation groups 130 and 132, and one group of expert evaluators, shown in FIG. 1 as evaluation group 134.

At block 154 C-SATS™/CSATS™ system 120 can identify two separate crowd-sourcing services (CSSs) to recruit evaluators for evaluation groups 130 and 132. One example crowd-sourcing service is the Mechanical Turk™ by Amazon.com Inc. of Seattle, Wash. The Mechanical Turk™ service allows a “requester” (employer) to provide one or more Human Intelligence Tasks (HITs) for completion, with each HIT being work that utilizes human intelligence. The HITs are advertised on a web site that summarizes the task to be performed and a monetary reward for successful task completion. A “provider” (piecework employee) can review the web site for HIT and rewards, and can then choose to complete HITs to obtain the advertised rewards. The Mechanical Turk™ service allows a requester to select providers with certain qualifications, such as a minimum number of HITs completed successfully. The Mechanical Turk™ service includes an application programming interface for submitting HITs, retrieving completed work, and evaluating (approving/rejecting) completed work. Other websites, such as, but not limited to, university websites and/or the Facebook™ website provided by Facebook, Inc. of Menlo Park, Calif. can be act as crowd-sourcing sources and request a task be completed by a number of people.

Other groups, such as evaluation group 134, can be contacted directly by C-SATS™/CSATS™ system 120. For example, C-SATS™/CSATS™ system 120 can be used to generate and distribute e-mail and/or other electronic communications to evaluators. As another example, C-SATS™/CSATS™ system 120 can be used to generate a communication to respond to request for evaluating media content 152 that can be provided to evaluators via telephone, paper, or one or more other media. For example, C-SATS™/CSATS™ system 120 can have, maintain, and/or have access to contact information for evaluators, such as e-mail addresses, phone numbers, and/or other information to contact evaluators.

After determining evaluation groups 130, 132, and 134, C-SATS™/CSATS™ system 120 can contact crowd-sourcing service 140 via request evaluation group 156 to recruit at least a number n1 of evaluators to evaluate media content associated with request for evaluating media content 152. In scenario 100, evaluators recruited by crowd-sourcing service 140 form evaluation group 130. Also, C-SATS™/CSATS™ system 120 can contact crowd-sourcing service 142 via request evaluation group 158 to recruit at least evaluators to evaluate media associated with request for evaluating media content 152. For example, crowd-sourcing service 140 can be a service similar to the above-mentioned Mechanical Turk™ service, and crowd-sourcing service 142 can be a web-page/social media service. In scenario 100, C-SATS™/CSATS™ system 120 can send request a number n3 of evaluation messages 160a, 160b . . . to directly recruit evaluators for evaluation group 134. For example, evaluation messages 160a, 160b . . . can include e-mail messages, voice messages, and/or paper mail.

Once recruited, evaluators in evaluation groups 130, 132, 134 can evaluate the media content associated with request to evaluate media content 152 and provide respective evaluations of the media content. In some embodiments, C-SATS™/CSATS™ system 120 can be provided with information, such as names or other identification, to verify that an evaluator did not provide multiple evaluations. For example, C-SATS™/CSATS™ system 120 can compare identifying information of evaluators within an evaluation group and/or evaluators between evaluation groups to determine one or more evaluators that provide multiple evaluations. In response to identifying an evaluator providing multiple evaluations, C-SATS™/CSATS™ system 120 can discard some or all of the multiple evaluations; e.g., keep the first or last evaluation of the multiple evaluations, keep the evaluation with the most content, such as a narrative response, discard all evaluations. If evaluators are in turn evaluated, C-SATS™/CSATS™ system 120 can provide a negative evaluation of some or all evaluators providing multiple evaluations.

FIG. 1 shows a number n1 of evaluations 162 received from evaluation group 130. C-SATS™/CSATS™ system 120 can be used to assess evaluations 162; for example, determine whether evaluations of the media content are complete and have proper information. In some cases, an evaluation can include evaluator-assessment questions to assess whether the evaluator observed the media content carefully enough to provide an evaluation; e.g., questions about subject matter and/or specific items in the media content. In these cases, C-SATS™/CSATS™ system 120 can assess evaluations based on responses to evaluator-assessment questions. Other techniques for assessing evaluations are possible as well.

In scenario 100, C-SATS™/CSATS™ system 120 can determine that a number m1 of the n1 evaluations 162 are assessed negatively, where m1≦n1. Then, C-SATS™/CSATS™ system 120 can send negative evaluation response(s) (NERs) 164 to inform crowd-sourcing service 140 about the m1 negative evaluations. In scenario 100, crowd-sourcing service 140 responds by recruiting m1 new evaluators for evaluation group 130. The m1 new evaluators can provide m1 evaluations 166, and in scenario 100, all m1 evaluations 166 are assessed positively.

C-SATS™/CSATS™ system 120 can send positive evaluation response(s) (PERs) 168 related to a total of n1 positive evaluations (n1−m1 positive evaluations from the original members of evaluation group 130 plus m1 positive evaluations from the new members of evaluation group 130) to crowd-sourcing service 140. Positive evaluation response(s) 168 can include rewards, positive ratings, and/or positive messages (e.g., a message expressing gratitude) for the positively-assessed evaluators.

FIG. 1 shows a number n2 of evaluations 170 received from evaluation group 132. C-SATS™/CSATS™ system 120 can be used to assess evaluations 170 with the same or similar techniques as used for evaluations 162 from evaluation group 130 discussed above. In scenario 100, C-SATS™/CSATS™ system 120 can determine that, of the n2 received evaluations 170, a number m2 of the n2 evaluations 162 are assessed negatively, and a number p2 of the n2 evaluations 162 are assessed positively, where m2+p2=n2. Then, C-SATS™/CSATS™ system 120 can send negative evaluation response(s) 172 to inform negatively-evaluated evaluators in evaluation group 132 about the m2 negative evaluations and can send positive evaluation response(s) 174 inform positively-evaluated evaluators in evaluation group 132 about the p2 positive evaluations.

Negative evaluation response(s) 172 can include information about erroneous aspects of an evaluation, information about any rewards available, and/or information about correcting/resubmitting an evaluation to enable the evaluator to receive a positive evaluation response. In some cases, negative evaluation response(s) 172 can be omitted; e.g., a “no response” outcome to an evaluation can indicate a negative evaluation response. Positive evaluation response(s) 174 can be the same as or similar to positive evaluation response(s) 168 discussed above.

FIG. 1 shows that p3 evaluators of evaluation group 134 provided evaluations 180a, 180b, 180c, 180d . . . C-SATS™/CSATS™ system 120 can be used to assess evaluations 180a, 180b, 180c, 180d . . . with the same or similar techniques as used for evaluations 162 from evaluation group 130 discussed above.

In scenario 100, evaluation 180a is received from an evaluator E1 at C-SATS™/CSATS™ system 120 and assessed as a positive evaluation. C-SATS™/CSATS™ system 120 can respond to evaluator E1 with positive evaluation response 182a. Scenario 100 continues with evaluation 180b being received from an evaluator E2 and assessed as a negative evaluation. C-SATS™/CSATS™ system 120 can respond to evaluator E2 with negative evaluation response 184a. In scenario 100, evaluator E2 does not respond to negative evaluation report 184a. Scenario 100 continues with evaluation 180c being received from an evaluator E3 and assessed as a negative evaluation. C-SATS™/CSATS™ system 120 can respond to evaluator E3 with negative evaluation response 184b. In scenario 100, evaluator E3 responds to negative evaluation report 184b with (revised) evaluation 180d. C-SATS™/CSATS™ system 120 can assess evaluation 180d as a positive evaluation and respond to evaluator E3 with positive evaluation response 182b. Positive evaluation responses 182a, 182b can be the same as or similar to positive evaluation response(s) 168, 174 discussed above. Negative evaluation responses 184a, 184b can be the same as or similar to negative evaluation response(s) 172 discussed above.

Scenario 100 continues at block 190 after all responses to requests 156, 158, 160a, 160b . . . have been received. In some examples, a predetermined amount of time (e.g., 3 hours, two days, one month) can be allowed for evaluators to provide responses to requests 156, 158, 160a, 160b . . . . Any responses received after the predetermined amount of time can be ignored, or in some cases, accepted even if tardy.

At block 190 of FIG. 1, as responses to the requests are received from each group of evaluators, the evaluations can be assessed. In some embodiments, only positively evaluated evaluations are assessed at block 190. For example, if evaluations of the surgical procedure are numerical in origin, then mean, standard deviation, and/or other statistics of each evaluator group can be determined and compared. Once each group has completed its evaluations, and perhaps at times during the evaluation process and/or upon request by requestor 110, evaluation report 192 can be generated with the resulting evaluation data, statistics, and comparisons between groups.

As another example of reporting results, the results from each group can be provided to libraries of structured assessment tools for generating other assessments, perhaps after manipulating the results data to be suitable for use by these libraries. Selection of one or more libraries of structured assessment tools can be made as part of the request to evaluate the media content. As another output, raw and/or processed results data from some or all evaluators of some or all evaluator groups can be provided for use by other systems (e.g., expert systems, machine-learning systems, neural networks). After providing evaluation report 192, scenario 100 can complete.

### Applying C-SATS™/CSATS™ to Evaluate Surgical Performance

C-SATS™/CSATS™ system 120 was used as part of a study of the effects of warming up on a VR simulator on dry lab performances of robotic surgery. In this study, C-SATS™/CSATS™ system 120 was used to measure the impact of virtual reality (VR) warm-up on the performance of robotic surgery. Data was collected from September 2010 to January 2012 by study personnel and members of the staff at University of Washington Medical Center and the Madigan Army Medical Center. Fifty-one subjects consisting of resident and attending surgeons from the University of Washington Medical Center and the Madigan Army Medical Center were recruited to the study. Subjects performed a series of tasks on the da Vinci surgical robot to demonstrate proficiency with the surgical system. Then subjects performed dry lab surgical tasks either with or without a warm-up session on a Mimic Technologies dV-Trainer. Two criterion tasks were used, rocking pegboard and intra-corporeal suturing. This resulted in 49 videos of each task (for each of the two tasks, two videos were lost due to recording errors).

C-SATS™/CSATS™ system 120 was configured to request evaluations of depth perception, bimanual dexterity and efficiency using categories of the GEARS scoring tool (each with Likert scale of 1-5), thus C-SATS™/CSATS™ global scores in the study range from 3 to 15. Three attending surgeons, each with more than 4 years and 150 cases of experience on the da Vinci were recruited to grade the 98 videos included in this study. The attending surgeon's grades were collected to be compared to grades provided by a crowd.

The Amazon Mechanical Turk™ (AMT) marketplace was used as a crowd-sourcing service to collect crowd assessments of the surgical performances in this study. AMT allows for the creation of Human Intelligence Tasks (HITs) that can be completed by AMT users in return for being paid a small fee ($0.25 for rocking pegboard videos, $0.50 for suturing videos). HyperText Markup Language (HTML) form surveys for evaluating each of the 98 videos were automatically generated using a Matlab script. A PHP Hypertext Preprocessor (PHP) Common Gateway Interface (CGI) script on a web server received the survey responses, stored the scores on a server and generated a unique survey code each time a video was scored. These surveys were embedded in the HITs.

To request evaluation of video media content of the surgical performances, a HIT requesting 30 crowd responses for each of the 49 rocking pegboard and 49 suturing tasks was generated using the Mechanical Turk™ web interface. 30 responses from the crowd was sufficient to judge the overall agreement between surgeons and the crowd and a sufficiently high number to provide a sample mean representative of the crowd response population mean. Mechanical Turk™ manages the assignment of HITs to workers so that each worker may complete multiple HITs but they may only complete a given HIT once. Thus the 30 responses collected per performance are from unique workers.

In order to assure that the workers paid attention, attention check (AC) questions were added to the survey. If these questions were answered incorrectly, the work from these workers was rejected and the HIT re-launched for other workers to complete to assure at least 30 valid responses per performance.

An HTML form-based GEARS Grading Suite was created to facilitate grading by the attending surgeons; i.e., to act as an evaluation form. Prior to performing grading, the group of attending surgeons watched 10 example videos of similar tasks from a different data set and discussed the grades they would assign, in order to improve grader agreement (grader workshop).

Agreement between the mean surgeon-provided C-SATS™/CSATS™ subset GEARS score and the mean crowd-provided score are the basis for assessing the validity of the C-SATS™/CSATS™ approach to grading. The hypothesis that VR warm-up improves performance on the da Vinci is assessed by comparing the distribution of C-SATS™/CSATS™ scores from subjects who did VR warm-up to those who did not using a student's t-test.

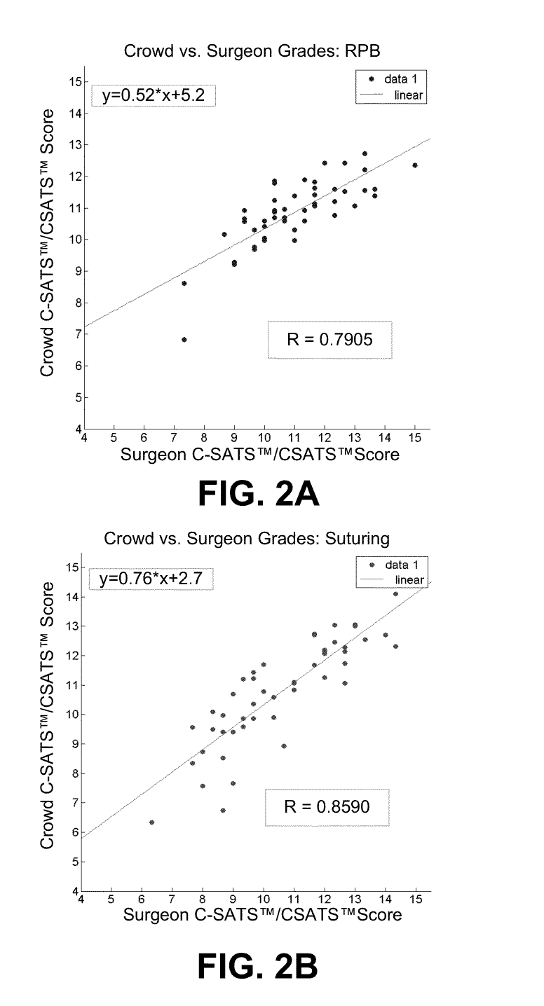

FIG. 2A is a graph of crowd-surgeon coefficients, including a best-fit line, for the rocking pegboard task, and FIG. 2B is a graph of crowd-surgeon coefficients, including a best-fit line, for the suturing task, each in accordance with an embodiment. Each of FIGS. 2A, 2B, and Table 1 show agreement between surgeon scores and C-SATS™/CSATS™ scores. Agreement is expressed in Table 1 using Cronbach's alpha.

TABLE 1

| | Suturing | Rocking Pegboard |
|---|---|---|
| Agreement Measure | Task | (RPB) Task |
| Correlation Coefficient (R) | 0.859 | 0.791 |
| Cronbach's alpha | 0.92 | 0.84 |

FIGS. 2A, 2B, and Table 1 each indicate a correlation between surgeon grading and C-SATS™/CSATS™ scores to be approximately 0.79 for the rocking pegboard task and approximately 0.86 for the suturing task. In particular, 67% of the C-SATS™/CSATS™ scores for rocking pegboard and 69% of the C-SATS™/CSATS™ scores for suturing fell within 1 point of the surgeon-provided score.

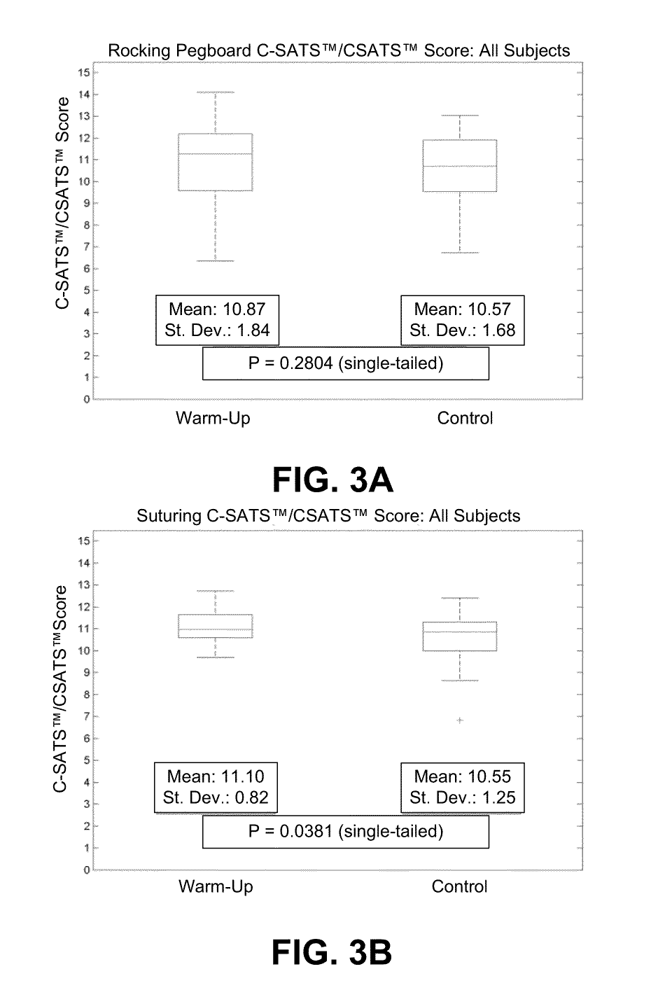

FIGS. 3A and 3B are respective graphs of C-SATS™/CSATS™ scores for the rocking pegboard task and the suturing task, each graph representing data for VR warm-up and without warm-up (control group) for the respective task, in accordance with an embodiment. FIGS. 3A, 3B, and Table 2 show the impact of VR warm-up on robotic surgical performance on dry-lab tasks.

In particular, Table 2 below shows warm-up impact on surgeon C-SATS™/CSATS™ scores, where a * in Table 2 indicates statistically significance.

TABLE 2

| | | | Warm- | | |
|---|---|---|---|---|---|
| Group | Size | Task | up | Control | t-test |
| All Subjects | 51 | Rocking Pegboard | 10.87 | 10.57 | 0.280 |
| Experts | 17 | Rocking Pegboard | 12.55 | 10.90 | 0.030 * |
| Novices | 34 | Rocking Pegboard | 10.25 | 10.32 | 0.548 |
| All Subjects | 51 | Suturing | 11.10 | 10.55 | 0.038 * |
| Experts | 34 | Suturing | 11.78 | 10.66 | 0.045 * |
| Novices | 17 | Suturing | 10.84 | 10.48 | 0.136 |

When considered as a whole, VR warm-up showed a statistically significant impact on the C-SATS™/CSATS™ scores of subjects performing a suturing task. The subject population of 51 subjects was divided into “expert” and “novice” subjects, and an impact of VR warm-up was considered the impact on these groups. Experts (17 subjects) were those subjects having performed at least 10 laparoscopic cases as primary surgeon and 10 robotic cases as primary surgeon. Novices (34 subjects) were those subjects who did not meeting these criteria. When considered in this way, the experienced groups benefited from VR warm-up to a statistically significant extent on both tasks.

Excellent agreement was found between performance assessments provided by a group of experienced surgeons trained to accurately assess surgical performances and groups of anonymous untrained individuals on the Internet paid a small amount to assess surgical performances. The cost to assess these short videos of dry lab surgical performances was found to be small: $10.07 per rocking pegboard video and $15.67 per suturing video. Furthermore, crowds on the Internet provided scores within 108 hours for 49 rocking pegboard videos and just less than 9 hours for 49 suturing videos. The group of attending surgeons took over a month to complete the grading task and the grading task only took between 3-8 minutes for each survey. In this study, C-SATS™/CSATS™ scores from the crowd are highly correlated with scores provided by surgeons; indicating C-SATS™/CSATS™ system 120 is a valid surgical assessment tool with certain specific advantages over other means of assessing surgical performance.

In another study, the accuracy of crowd workers recruited using Mechanical Turk™ and Facebook™ crowd-source services was compared to experienced surgical faculty grading a recorded dry-lab robotic surgical suturing performance using three performance domains from a validated assessment tool. Evaluator free-text comments describing their rating rationale were used to explore a relationship between the language the crowd used and grading accuracy.

In this study, three evaluation groups were used to evaluate media content related to surgical procedures: a first group of Mechanical Turk™ users, a second group of Facebook™ users, and a third group teaching surgeons whose expertise and practice involve robotic surgery. The first group included five hundred and one subjects recruited through the Amazon.com Mechanical Turk™ crowd-sourcing platform. To be eligible, a subject in the first group had to be an active Mechanical Turk™ user that had completed 50 or more Human Intelligence Tasks and had achieved a greater than 95% approval rating. The second group had 110 subjects recruited using Facebook™. The third group, acting as a control, included ten experienced robotic surgeons, who have all practiced as attending surgeons for a minimum of three years with predominantly minimally invasive surgery practices and who were familiar with evaluating surgical performances by video analysis.

C-SATS™/CSATS™ system 120 was used for managing contact with each of the three groups and evaluating evaluations provided by each of the three groups. Mechanical Turk™ and Facebook™ announcements were posted on the respective websites associated with the first and second groups and recruitment emails were sent to the experienced surgeons in the third group. While each Mechanical Turk™ evaluator in the first group was compensated 1.00 USD for participating, neither the Facebook™ evaluators in the second group nor the surgeon evaluators in the third group received monetary compensation. All evaluators were required to be over the age of 18 years.

The evaluation of media content included two parts. First, subjects were asked to answer a qualification question based on a side-by-side video of two surgeons performing a Fundamentals of Laparoscopic Surgery (FLS) block transfer task. Following the qualification question, a criterion test involved rating a less than 2 minute robotic surgery suture knot-tying video of an above average performance based on existing benchmark data. Grades of the criterion test were obtained from ten available experienced surgeons in the third group as a ground truth grade for evaluating the video media content associated with the criterion test.

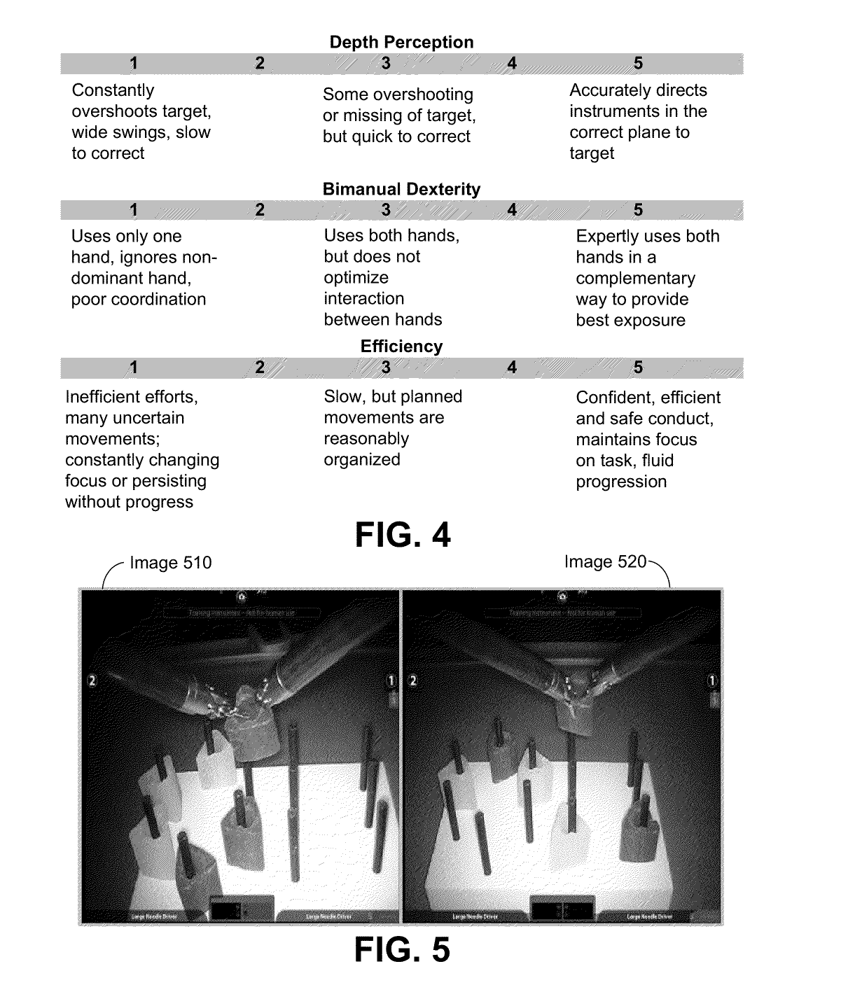

FIG. 4 depicts an example evaluation form used in this study, in accordance with an embodiment. The evaluation form was adapted from the Global Evaluative Assessment of Robotic Skills (GEARS) validated robotic surgery rating tool and hosted online. Each of the subjects from the three groups completed the evaluation form.

FIG. 5 exhibits images 510, 520 from a block transfer task side-by-side video used to screen subjects as part of the qualification question, in accordance with an embodiment. Image 510, displayed on the left side of the side-by-side video, demonstrates a surgeon performing with high skill. Image 520, displayed on the right side of the side-by-side video, presents a surgeon performing with intermediate skill based on published benchmark metrics for this particular task. Subject evaluators were directed to answer the qualification question by indicating which video showed the surgeon of higher skill to assess an evaluator's discriminative ability.

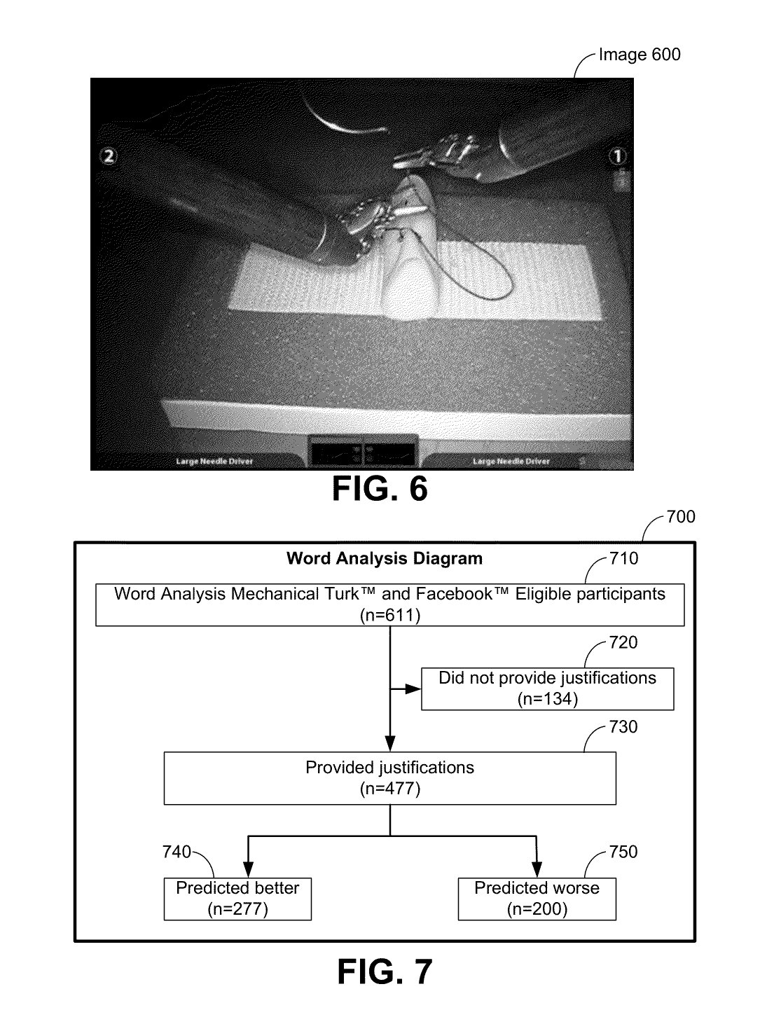

FIG. 6 exhibits image 600 from video media content related to a suturing task graded by evaluation groups, in accordance with an embodiment. In particular, image 600 is from an intra-corporeal robotic suturing video that was evaluated by the evaluation groups of this study. After watching the video media content, each reviewer rated the suturing performance on three domains—depth perception, bimanual dexterity, and efficiency. The domains were chosen from the six domains included in the GEARS tool and were rated on a Likert scale from one to five. The global performance rating was obtained by summing the ratings of the three domains with a scale of 3 to 15. An attention question was also embedded within the criterion test to ensure that the evaluator was actively paying attention and if the question was answered incorrectly, the subject was excluded in the study. In the graded media content, no subject-identifying features were visible.

Each evaluator was asked to describe his/her grading rationale in a free-text box following each domain rating. In this study, a focus was placed on using the occurrence of style words, which are words that do not carry content individually, such as “the,” “and,” “but,” and “however,” to identify more accurate responses, based on the concept that non-content words in English can help identify aspects of the writer's mood, expertise, and other characteristics.

FIG. 7 is word analysis diagram 700, in accordance with an embodiment. Data for word analysis diagram 700 was provided by C-SATS™/CSATS™ system 120. Block 710 of diagram 700 indicates that 611 qualifying responses from the first and second groups were received. Of those responses, 134 of those responses did not provide justification, as indicated in block 720. Of the remaining 477 responses (see block 730) that provided justifications, separation was achieved by computing the distance between each response and the expert average, and separating the responses along the median distance into roughly equal-size parts: 277 better responses as shown at block 740 and 200 worse responses as shown at block 750. Because responses based on the evaluation form shown in FIG. 4 cannot be presumed to be interval-valued, but finding the distance between a response and the expert average does so, splitting the responses into two coarse categories serves to reduce the effect of this assumption.

A minimum of 400 ratings was determined a priori for the Mechanical Turk™ group to show equivalency with the average (mean) expert grade with >90% power, assuming a standard deviation in grades of three. To establish equivalency, the entire 95% confidence interval for the mean Mechanical Turk™ grade had to be contained within the equivalence margin surrounding the gold standard grade. The a priori determined of equivalence was +/−1 point, assuming average rating differences of no greater than 0.5 points. The study had a goal of obtaining at least 100 Facebook™ user ratings to test the feasibility of alternative recruitment methods to the Mechanical Turk™ and direct contact with (expert) evaluators in an evaluation group. All confidence intervals were two-sided and not adjusted for multiple testing of groups. Statistical analyses were conducted using the R (v2.15) statistical computing environment. Explanations for the ratings for each of the domains were also collected. Four hundred seventy-six participants from Mechanical Turk™ and Facebook™ provided text responses.

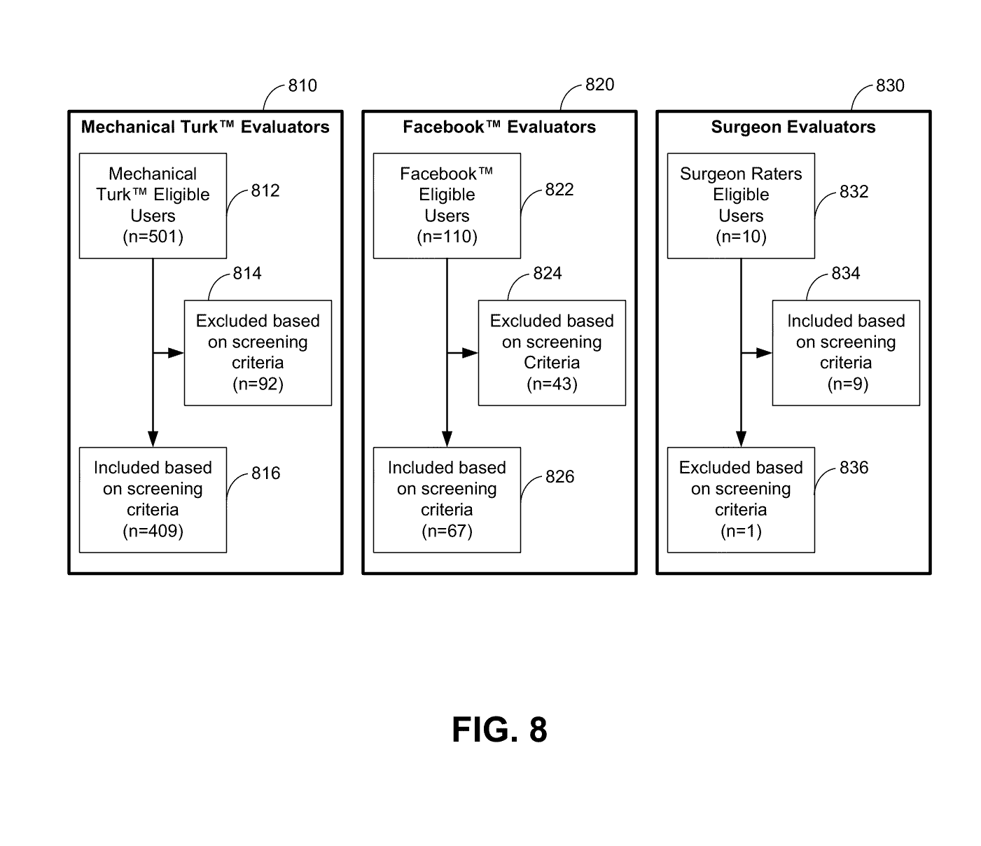

FIG. 8 depicts three inclusion/exclusion diagrams 810, 820, 830, in accordance with an embodiment. Inclusion/exclusion diagram 810 shows that out of 501 eligible users that could be evaluators selected by the Mechanical Turk™ crowd-sourcing service, 92 of the 501 eligible users were excluded based on screening criteria, leaving 409 Mechanical Turk™ users (82% of the initial responses) to be included as evaluators. Inclusion/exclusion diagram 820 shows that out of 110 eligible users that could be evaluators selected via the Facebook™ crowd-sourcing service, 43 of the 110 eligible users were excluded based on screening criteria, leaving 67 Facebook™ users (61% of the initial responses) to be included as evaluators. Inclusion/exclusion diagram 830 shows that out of 10 eligible surgeons that could be evaluators, one of the 10 eligible surgeons were excluded based on screening criteria, leaving 9 surgeons (90% of the initial responses) to be included as evaluators.

Table 3 below summarizes grades assigned by each subject group for the criterion test.

TABLE 3

| | Mechanical | | |
|---|---|---|---|
| Evaluation Group: | Turk ™ | Facebook ™ | Surgeons |
| Initial N | 501 | 107 | 10 |
| Qualified N | 409 (82%) | 67 (63%) | 9 (90%) |
| C-SATS ™/ | | | |
| CSATS ™ | | | |
| Mean (SD) | 12.21 (2.35) | 12.06 (2.01) | 12.11 (1.45) |
| 95% CI | 11.98, 12.44 | 11.56, 12.55 | 11.00, 13.22 |
| Grade, n (%) | | | |
| 3 | 0 | 0 | 0 |
| 4 | 1 (0.2) | 0 | 0 |
| 5 | 2 (0.5) | 0 | 0 |
| 6 | 10 (2.4) | 3 (4.5) | 0 |
| 7 | 11 (2.7) | 0 | 0 |
| 8 | 14 (3.4) | 0 | 0 |
| 9 | 17 (4.2) | 4 (6.0) | 0 |
| 10 | 26 (6.4) | 3 (4.5) | 0 |
| 11 | 36 (8.8) | 11 (16.4) | 4 (44.4) |
| 12 | 78 (19.1) | 17 (25.4) | 3 (33.3) |
| 13 | 76 (18.6) | 10 (14.9) | 0 |
| 14 | 73 (17.9) | 16 (23.9) | 1 (11.1) |
| 15 | 65 (15.9) | 3 (4.5) | 1 (11.1) |

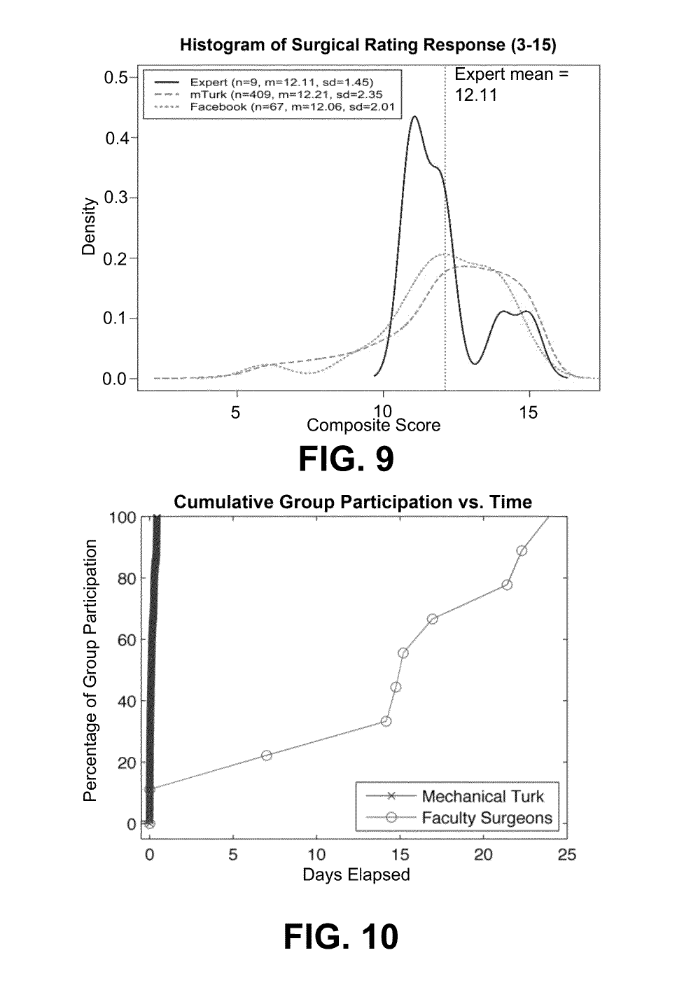

FIG. 9 is a composite graph of scoring density from three evaluation groups, in accordance with an embodiment. FIG. 9 and Table 3 both indicate that surgeon evaluators graded the skills assessment video with a mean score 12.11, yielding an equivalence window of 11.11 to 13.11. Mechanical Turk™ and Facebook™ evaluators rated the video with respective mean scores of 12.21 (95% confidence interval (CI) between 11.98 to 12.43) and 12.06 (95% confidence interval between 11.57 to 12.55), respectively. Confidence intervals for both crowd-sourced evaluation groups were contained entirely within the window of equivalence with expert surgeons. Bias from the expert surgeon rating was small in both crowd-sourced evaluation groups, with rating differences of +0.10 and −0.05 points for Mechanical Turk™ and Facebook™ users, respectively.

Table 4 below indicates times to receive full responses from each evaluation group.

TABLE 4

| Evaluation Group | # of Usable Responses | # of Days to Respond |
|---|---|---|
| Mechanical Turk ™ | 409 | 1 |
| Facebook ™ | 67 | 25 |
| Faculty Surgeons | 9 | 24 |

FIG. 10 is a plot of evaluation group participation over time, in accordance with an embodiment. In particular, FIG. 10 shows a plot of a percentage of submitted evaluations per evaluation group over time. Only participants who passed the qualification step are shown in the plot depicted in FIG. 10.

Response time from the different groups varied greatly. The Mechanical Turk™ crowd-sourcing service provided 409 usable responses in a 24 hour period as shown in FIG. 10. In contrast, it took 24 days to receive 9 surgeon responses and 25 days to generate 67 Facebook™ responses. One limitation is that only the Mechanical Turk™ evaluators were compensated. Perhaps more Facebook™ responses could have been generated at a quicker rate with compensation, however it is unlikely that a 1.00 USD offer would have accelerated surgeon participation.

With the Mechanical Turk™ and Facebook™ groups combined, 476 survey participants provided justification for their selections regarding all three domains. The number of times each frequently-occurring style word was determined for any of the explanations in the better versus worse responses. The probability of a word to occur given a good or bad response is related to the probability of a response being good or bad given the word occurring, according to Bayes' Theorem. It was found that the word “but” was much more likely to occur in the better set of responses and therefore, focused on “but,” and related negation words “however,” “despite,” “although,” and “though.” The existence of these words was used to split all qualifying responses into new predicted-better and predicted-worse categories. The predicted-better set contained 277 (58%) of the responses.

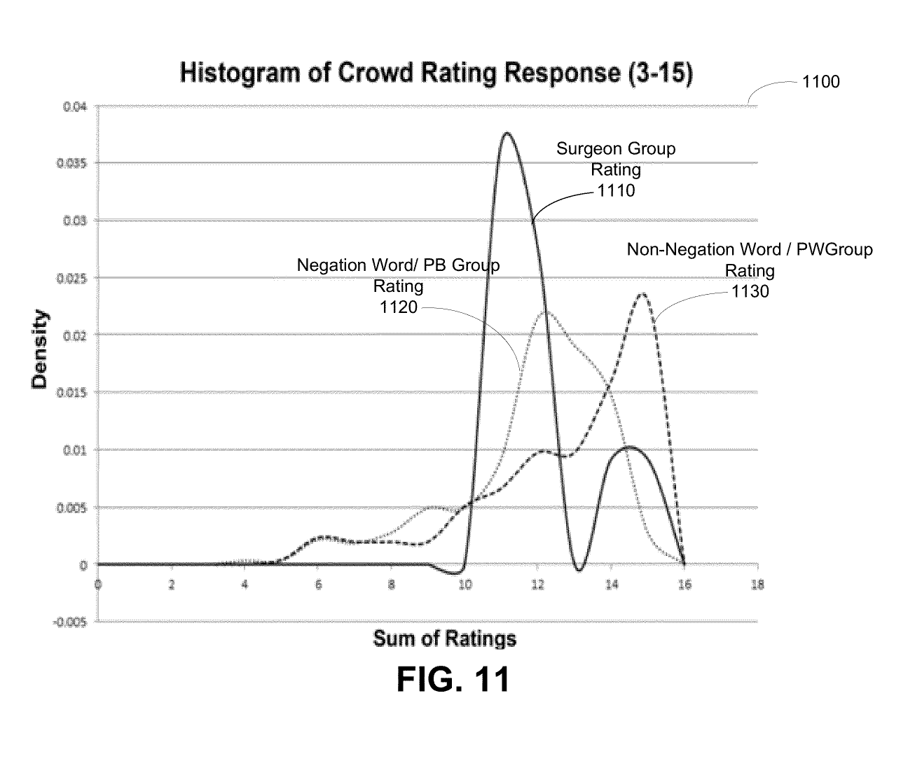

FIG. 11 is graph 1100 of scoring density based on evaluator's free-text use or non-use of negation words from three evaluation groups, in accordance with an embodiment. Graph 1100 includes plot 1110 of surgeon evaluation group ratings, plot 1120 of crowd evaluators who used negation words and so are in the predicted-better (PB) group, and plot 1120 of crowd evaluators who used non-negation words and so are in the predicted-worse (PW) group. As shown in FIG. 11, the differences between predicted-better and predicted-worse are numerically small, but statistically significant using non-parametric Mann-Whitney U test (p<0.00001) for each of the three dimensions of rating. The distance between the predicted-better responses are also closer to the expert average (as there were only nine expert responses, no statistical test was run).

An approach of using writing style cues to identify better responses is similar to the approach of using behavioral patterns for the same purpose. Meaningfully different ratings were isolated using writing style cues alone, as evidenced by significant differences between “predicted-better” and “predicted-worse” sets. Furthermore, these writing style cues can help identify more accurate responses, as the predicted-better responses were closer to the expert average. They were also more critical than the predicted-worse responses, which may be because negation words serve to identify more critical responses. It is also possible that the overall crowd is more lenient than experts and identifying more critical responses implies identifying more accurate ones. For example, one subject justified rating depth perception as a ‘four’ (which was equivalent to the rating given by the experts for depth perception) and stated that, “Making the knots seemed at first choppy, but looked better the second time a knot was made.” Using additional text cues may provide the ability to hone the crowds for specific tasks.

Surgery-naïve crowd workers can rapidly assess skill in a robotic suturing performance equivalent to experienced faculty surgeons. Out of a total possible global performance score of (3-15), ten experienced surgeons graded media content of a suturing video at a mean score of 12.11 (95% CI: 11.11 to 13.11). Mechanical Turk™ and Facebook™ graders rated the video at mean scores of 12.21 (95% CI: 11.98 to 12.43) and 12.06 (95% CI: 11.57 to 12.55), respectively. It took 24 hours to obtain responses from 501 Mechanical Turk™ subjects at C-SATS™/CSATS™ system 120, whereas it took 25 days for 10 faculty surgeons to complete the 3-minute survey. 110 Facebook™ subjects responded to C-SATS™/CSATS™ system 120 within 24 days. Language analysis indicated that crowd workers who used negation words (i.e. “but,” “although,” etc.) scored the performance more equivalently to experienced surgeons than crowd workers who did not (p<0.00001).

### Example

### Computing Network

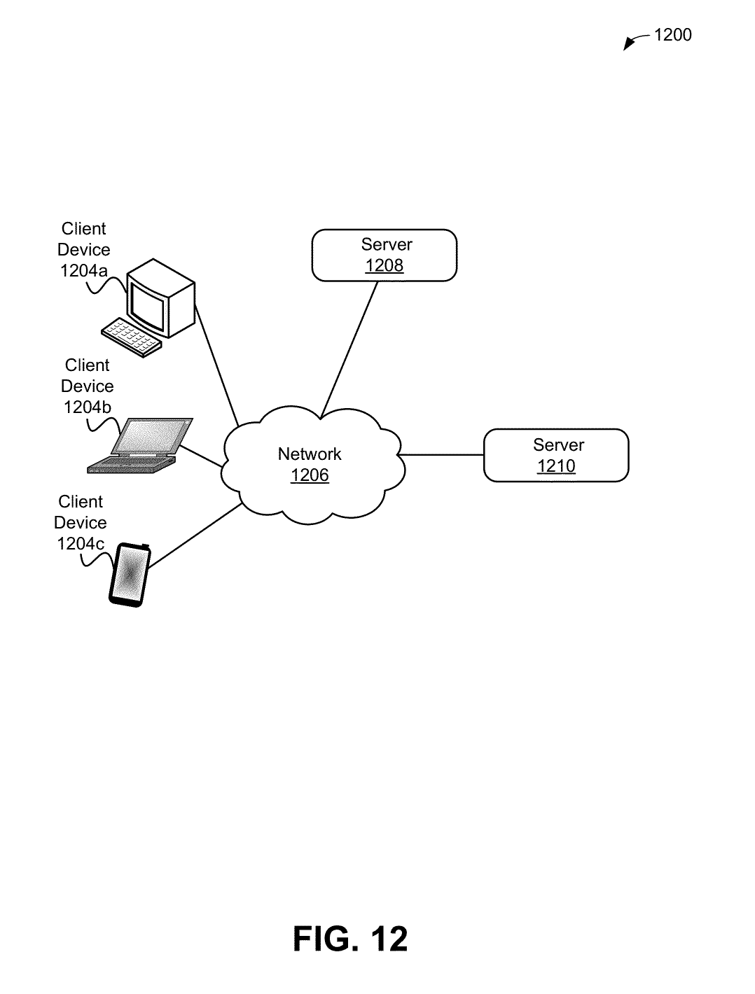

FIG. 12 is a block diagram of example computing network 1200 in accordance with an example embodiment. In FIG. 12, servers 1208 and 1210 are configured to communicate, via a network 1206, with client devices 1204a, 1204b, and 1204c. As shown in FIG. 12, client devices can include a personal computer 1204a, a laptop computer 1204b, and a smart-phone 1204c. More generally, client devices 1204a-1204c (or any additional client devices) can be any sort of computing device, such as a workstation, network terminal, desktop computer, laptop computer, wireless communication device (e.g., a cell phone or smart phone), and so on.

The network 1206 can correspond to a local area network, a wide area network, a corporate intranet, the public Internet, combinations thereof, or any other type of network(s) configured to provide communication between networked computing devices. In some embodiments, part or all of the communication between networked computing devices can be secured.

Servers 1208 and 1210 can share content and/or provide content to client devices 1204a-1204c. As shown in FIG. 12, servers 1208 and 1210 are not physically at the same location. Alternatively, servers 1208 and 1210 can be co-located, and/or can be accessible via a network separate from network 1206. Although FIG. 12 shows three client devices and two servers, network 1206 can service more or fewer than three client devices and/or more or fewer than two servers. In some embodiments, servers 1208, 1210 can perform some or all of the herein-described methods; e.g., method 1400.

### Example Computing Device

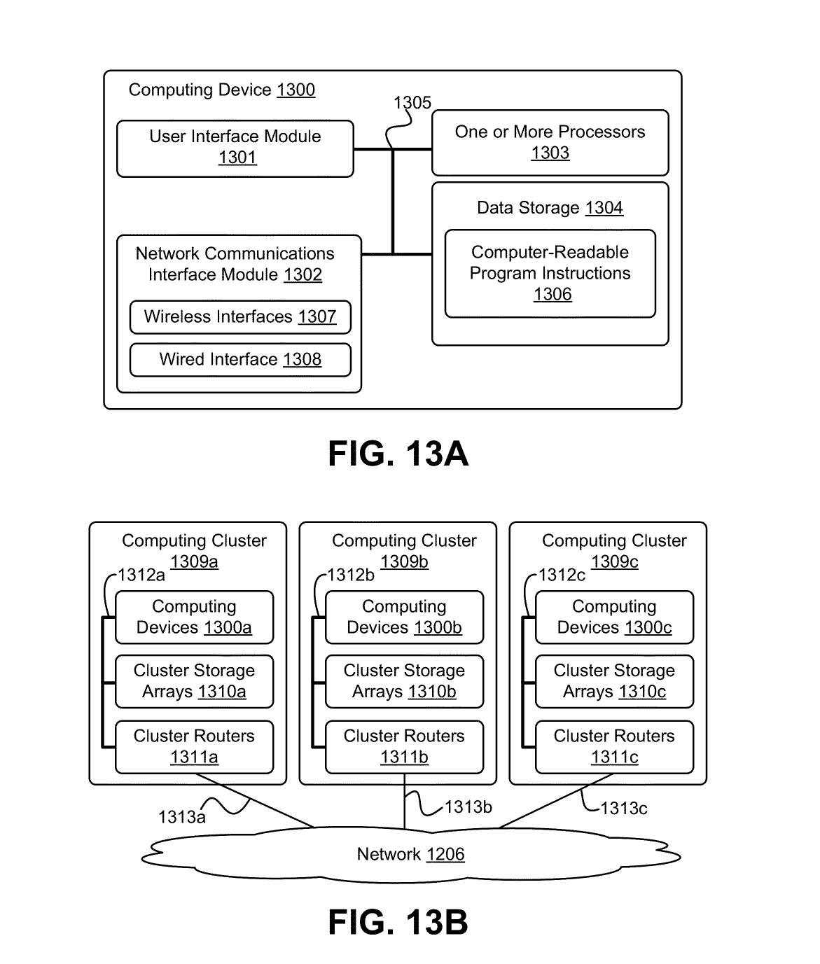

FIG. 13A is a block diagram of an example computing device 1300 including user interface module 1301, network communication interface module 1302, one or more processors 1303, and data storage 1304, in accordance with an embodiment.

In particular, computing device 1300 shown in FIG. 13A can be configured to perform one or more functions of requester 110, C-SATS™/CSATS™ system 120, evaluation group 130, 132, 134, crowd-sourcing service 140, 142, client devices 1204a-1204c, network 1206, and/or servers 1208, 1210 and/or one or more functions of method 1400. Computing device 1300 may include a user interface module 1301, a network communication interface module 1302, one or more processors 1303, and data storage 1304, all of which may be linked together via a system bus, network, or other connection mechanism 1305.

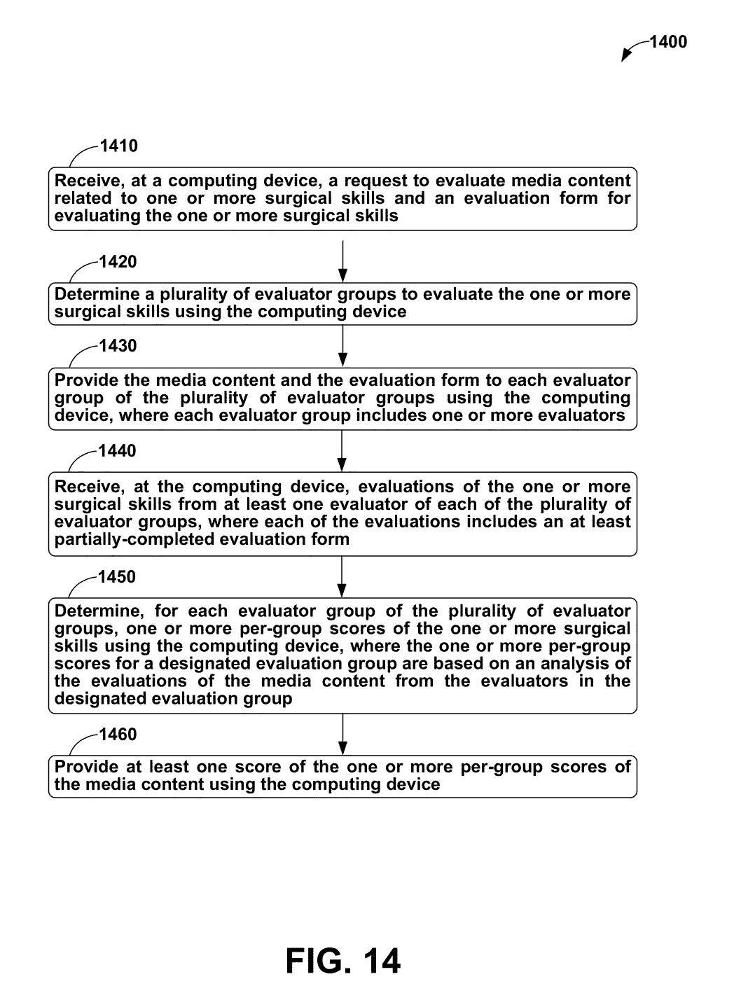

Computing device 1300 can be a desktop computer, laptop or notebook computer, personal data assistant (PDA), mobile phone, embedded processor, touch-enabled device, or any similar device that is equipped with at least one processing unit capable of executing machine-language instructions that implement at least part of the herein-described techniques and methods, including but not limited to method 1400 described with respect to FIG. 14.

User interface 1301 can receive input and/or provide output, perhaps to a user. User interface 1301 can be configured to send and/or receive data to and/or from user input from input device(s), such as a keyboard, a keypad, a touch screen, a computer mouse, a track ball, a joystick, and/or other similar devices configured to receive input from a user of the computing device 1300.

User interface 1301 can be configured to provide output to output display devices, such as one or more cathode ray tubes (CRTs), liquid crystal displays (LCDs), light emitting diodes (LEDs), displays using digital light processing (DLP) technology, printers, light bulbs, and/or other similar devices capable of displaying graphical, textual, and/or numerical information to a user of computing device 1300. User interface module 1301 can also be configured to generate audible output(s), such as a speaker, speaker jack, audio output port, audio output device, earphones, and/or other similar devices configured to convey sound and/or audible information to a user of computing device 1300.

Network communication interface module 1302 can be configured to send and receive data over wireless interface 1307 and/or wired interface 1308 via a network, such as network 1206. Wireless interface 1307 if present, can utilize an air interface, such as a Bluetooth®, Wi-Fi®, ZigBee®, and/or WiMAX™ interface to a data network, such as a wide area network (WAN), a local area network (LAN), one or more public data networks (e.g., the Internet), one or more private data networks, or any combination of public and private data networks. Wired interface(s) 1308, if present, can include a wire, cable, fiber-optic link and/or similar physical connection(s) to a data network, such as a WAN, LAN, one or more public data networks, one or more private data networks, or any combination of such networks.

In some embodiments, network communication interface module 1302 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well as or in addition to those listed herein to secure (and then decrypt/decode) communications.

Processor(s) 1303 can include one or more central processing units, computer processors, mobile processors, digital signal processors (DSPs), graphics processing units (GPUs), microprocessors, computer chips, and/or other processing units configured to execute machine-language instructions and process data. Processor(s) 1303 can be configured to execute computer-readable program instructions 1306 that are contained in data storage 1304 and/or other instructions as described herein.

Data storage 1304 can include one or more physical and/or non-transitory storage devices, such as read-only memory (ROM), random access memory (RAM), removable-disk-drive memory, hard-disk memory, magnetic-tape memory, flash memory, and/or other storage devices. Data storage 1304 can include one or more physical and/or non-transitory storage devices with at least enough combined storage capacity to contain computer-readable program instructions 1306 and any associated/related data and data structures.

Computer-readable program instructions 1306 and any data structures contained in data storage 1306 include computer-readable program instructions executable by processor(s) 1303 and any storage required, respectively, to perform at least part of herein-described methods, including, but not limited to method 1400 described with respect to FIG. 14.

FIG. 13B depicts a network 1206 of computing clusters 1009a, 1009b, 1009c arranged as a cloud-based server system in accordance with an example embodiment. Data and/or software for C-SATS™/CSATS™ system 120 can be stored on one or more cloud-based devices that store program logic and/or data of cloud-based applications and/or services. In some embodiments, C-SATS™/CSATS™ system 120 can be a single computing device residing in a single computing center. In other embodiments, C-SATS™/CSATS™ system 120 can include multiple computing devices in a single computing center, or even multiple computing devices located in multiple computing centers located in diverse geographic locations.

In some embodiments, data and/or software for C-SATS™/CSATS™ system 120 can be encoded as computer readable information stored in tangible computer readable media (or computer readable storage media) and accessible by client devices 1204a, 1204b, and 1204c, and/or other computing devices. In some embodiments, data and/or software for C-SATS™/CSATS™ system 120 can be stored on a single disk drive or other tangible storage media, or can be implemented on multiple disk drives or other tangible storage media located at one or more diverse geographic locations.

FIG. 13B depicts a cloud-based server system in accordance with an example embodiment. In FIG. 13B, the functions of C-SATS™/CSATS™ system 120 can be distributed among three computing clusters 1309a, 1309b, and 1308c. Computing cluster 1309a can include one or more computing devices 1300a, cluster storage arrays 1310a, and cluster routers 1311a connected by a local cluster network 1312a. Similarly, computing cluster 1309b can include one or more computing devices 1300b, cluster storage arrays 1310b, and cluster routers 1311b connected by a local cluster network 1312b. Likewise, computing cluster 1309c can include one or more computing devices 1300c, cluster storage arrays 1310c, and cluster routers 1311c connected by a local cluster network 1312c.

In some embodiments, each of the computing clusters 1309a, 1309b, and 1309c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 1309a, for example, computing devices 1300a can be configured to perform various computing tasks of C-SATS™/CSATS™ system 120. In one embodiment, the various functionalities of C-SATS™/CSATS™ system 120 can be distributed among one or more of computing devices 1300a, 1300b, and 1300c. Computing devices 1300b and 1300c in computing clusters 1309b and 1309c can be configured similarly to computing devices 1300a in computing cluster 1309a. On the other hand, in some embodiments, computing devices 1300a, 1300b, and 1300c can be configured to perform different functions.

In some embodiments, computing tasks and stored data associated with C-SATS™/CSATS™ system 120 can be distributed across computing devices 1300a, 1300b, and 1300c based at least in part on the processing requirements of C-SATS™/CSATS™ system 120, the processing capabilities of computing devices 1300a, 1300b, and 1300c, the latency of the network links between the computing devices in each computing cluster and between the computing clusters themselves, and/or other factors that can contribute to the cost, speed, fault-tolerance, resiliency, efficiency, and/or other design goals of the overall system architecture.

The cluster storage arrays 1310a, 1310b, and 1310c of the computing clusters 1309a, 1309b, and 1309c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of C-SATS™/CSATS™ system 120 can be distributed across computing devices 1300a, 1300b, and 1300c of computing clusters 1309a, 1309b, and 1309c, various active portions and/or backup portions of these components can be distributed across cluster storage arrays 1310a, 1310b, and 1310c. For example, some cluster storage arrays can be configured to store one portion of the data and/or software of C-SATS™/CSATS™ system 120, while other cluster storage arrays can store a separate portion of the data and/or software of C-SATS™/CSATS™ system 120. Additionally, some cluster storage arrays can be configured to store backup versions of data stored in other cluster storage arrays.

The cluster routers 1311a, 1311b, and 1311c in computing clusters 1309a, 1309b, and 1309c can include networking equipment configured to provide internal and external communications for the computing clusters. For example, the cluster routers 1311a in computing cluster 1309a can include one or more internet switching and routing devices configured to provide (i) local area network communications between the computing devices 1300a and the cluster storage arrays 1301a via the local cluster network 1312a, and (ii) wide area network communications between the computing cluster 1309a and the computing clusters 1309b and 1309c via the wide area network connection 1313a to network 1206. Cluster routers 1311b and 1311c can include network equipment similar to the cluster routers 1311a, and cluster routers 1311b and 1311c can perform similar networking functions for computing clusters 1309b and 1309b that cluster routers 1311a perform for computing cluster 1309a.

In some embodiments, the configuration of the cluster routers 1311a, 1311b, and 1311c can be based at least in part on the data communication requirements of the computing devices and cluster storage arrays, the data communications capabilities of the network equipment in the cluster routers 1311a, 1311b, and 1311c, the latency and throughput of local networks 1312a, 1312b, 1312c, the latency, throughput, and cost of wide area network links 1313a, 1313b, and 1313c, and/or other factors that can contribute to the cost, speed, fault-tolerance, resiliency, efficiency and/or other design goals of the moderation system architecture.

### Example Methods of Operation

FIG. 14 is a flow chart of an example method 1400. Method 1400 can be carried out by a computing device, such as computing device 1300 discussed above in the context of FIG. 13A. In some embodiments, the computing device can be configured act as part or all of C-SATS™/CSATS™ system 120.

Method 1400 can begin at block 1410, where a computing device can receive a request to evaluate media content related to one or more surgical skills and an evaluation form for evaluating the one or more surgical skills, such as described above in the context of at least FIGS. 1, 4, and 6.

At block 1420, the computing device can determine a plurality of evaluator groups to evaluate the one or more surgical skills, such as described above in the context of at least FIGS. 1 and 7-11.

At block 1430, the computing device can provide the media content and the evaluation form to each evaluator group of the plurality of evaluator groups, where each evaluator group can include one or more evaluators, such as described above in the context of at least FIGS. 1, 4, and 6.

At block 1440, the computing device can receive evaluations of the one or more surgical skills from at least one evaluator of each of the plurality of evaluator groups, where each of the evaluations includes an at least partially-completed evaluation form, such as described above in the context of at least FIGS. 1 and 7-11.

At block 1450, the computing device can determine, for each evaluator group of the plurality of evaluator groups, one or more per-group scores of the one or more surgical skills using the computing device, where the one or more per-group scores for a designated evaluation group are based on an analysis of the evaluations of the media content from the evaluators in the designated evaluation group, such as described above in the context of at least FIGS. 1 and 7-11.

At block 1460, the computing device can provide at least one score of the one or more per-group scores of the media content using the computing device, such as described above in the context of at least FIGS. 1 and 7-11.

In some embodiments, method 1400 additionally includes determining a comparison of the per-group scores between evaluator groups of the plurality of evaluator groups, such as described above in the context of at least FIGS. 1 and 9-11. In particular of these embodiments, providing the at least one score of the one or more per-group scores also includes providing information about the comparison of the per-group scores, such as described above in the context of at least FIGS. 9-11. In other particular of these embodiments, each evaluation of the media content can include a score related to at least one surgical skill of the one or more surgical skills. Then, the per-group scores of the one or more surgical skills of a designated evaluator group of the plurality of evaluator groups can include a mean value of scores provided by the at least one evaluator of the designated evaluator group, such as described above in the context of at least FIGS. 9-11. In more particular of these embodiments, determining the comparison of the per-group scores includes determining a comparison of the mean values of scores between evaluator groups of the plurality of evaluator groups, such as described above in the context of at least FIGS. 9-11.

In other embodiments, at least one evaluator group of the plurality of evaluator groups is designated as an expert evaluator group, and where each evaluator in the expert evaluator group is designated as an expert about the subject, such as described above in the context of at least FIGS. 1, 2A, 2B, and 8-11. In particular of these embodiments, at least one evaluator in the expert evaluator group is a surgeon, such as described above in the context of at least FIGS. 2A, 2B, and 8-11. In other particular of these embodiments, at least one evaluator group of the plurality of evaluator groups is designated as an non-expert evaluator group, where each evaluator in the non-expert evaluator group is not designated as an expert about the subject, such as described above in the context of at least FIGS. 1, 2A, 2B, and 8-11. In more particular of these embodiments, providing the at least one score of the one or more per-group scores further includes comparing the per-group score of the expert evaluator group with the per-group score of the non-expert evaluator group, such as described above in the context of at least FIGS. 1, 2A, 2B, and 8-11.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

The above description provides specific details for a thorough understanding of, and enabling description for, embodiments of the disclosure. However, one skilled in the art will understand that the disclosure may be practiced without these details. In other instances, well-known structures and functions have not been shown or described in detail to avoid unnecessarily obscuring the description of the embodiments of the disclosure. The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize.

All of the references cited herein are incorporated by reference. Aspects of the disclosure can be modified, if necessary, to employ the systems, functions and concepts of the above references and application to provide yet further embodiments of the disclosure. These and other changes can be made to the disclosure in light of the detailed description.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

Numerous modifications and variations of the present disclosure are possible in light of the above teachings.

1. A method, comprising:
receiving, at a computing device, a request to evaluate media content related to one or more surgical skills and an evaluation form for evaluating the one or more surgical skills;
determining a plurality of evaluator groups to evaluate the one or more surgical skills using the computing device;
providing the media content and the evaluation form to each evaluator group of the plurality of evaluator groups using the computing device, wherein each evaluator group comprises one or more evaluators;
receiving, at the computing device, evaluations of the one or more surgical skills from at least one evaluator of each of the plurality of evaluator groups, wherein each of the evaluations comprises an at least partially-completed evaluation form;
determining, for each evaluator group of the plurality of evaluator groups, one or more per-group scores of the one or more surgical skills using the computing device, wherein the one or more per-group scores for a designated evaluation group are based on an analysis of the evaluations of the one or more surgical skills from the evaluators in the designated evaluation group; and
providing at least one score of the one or more per-group scores of the one or more surgical skills using the computing device.

2. The method of claim 1, further comprising:
determining a comparison of the per-group scores between evaluator groups of the plurality of evaluator groups.

3. The method of claim 2, wherein providing the at least one score of the one or more per-group scores further comprises providing information about the comparison of the per-group scores.

4. The method of claim 2, wherein each evaluation of the one or more surgical skills comprises a score related to at least one surgical skill of the one or more surgical skills, and wherein the per-group scores of the one or more surgical skills of a designated evaluator group of the plurality of evaluator groups comprises a mean value of scores provided by the at least one evaluator of the designated evaluator group.

5. The method of claim 4, wherein determining the comparison of the per-group scores comprises determining a comparison of the mean values of scores between evaluator groups of the plurality of evaluator groups.

6. The method of claim 1, wherein at least one evaluator group of the plurality of evaluator groups is designated as an expert evaluator group, and wherein each evaluator in the expert evaluator group is designated as an expert about the subject.

7. The method of claim 6, wherein at least one evaluator in the expert evaluator group is a surgeon.

8. The method of claim 6, wherein at least one evaluator group of the plurality of evaluator groups is designated as an non-expert evaluator group, and wherein each evaluator in the non-expert evaluator group is not designated as an expert about the subject.

9. The method of claim 8, wherein providing the at least one score of the one or more per-group scores further comprises comparing the per-group score of the expert evaluator group with the per-group score of the non-expert evaluator group.

10. A computing device, comprising:
a processor; and
a non-transitory tangible computer readable medium configured to store at least executable instructions, wherein the executable instructions, when executed by the processor, cause the computing device to perform functions comprising:
receiving a request to evaluate media content related to one or more surgical skills and an evaluation form for evaluating the one or more surgical skills,
determining a plurality of evaluator groups to evaluate the one or more surgical skills,
providing the media content and the evaluation form to each evaluator group of the plurality of evaluator groups, wherein each evaluator group comprises one or more evaluators,
receiving evaluations of the one or more surgical skills from at least one evaluator of each of the plurality of evaluator groups, wherein each of the evaluations comprises an at least partially-completed evaluation form,
determining, for each evaluator group of the plurality of evaluator groups, one or more per-group scores of the one or more surgical skills, wherein the one or more per-group scores for a designated evaluation group are based on an analysis of the evaluations of the one or more surgical skills from the evaluators in the designated evaluation group, and
providing at least one score of the one or more per-group scores of the one or more surgical skills.

11. The computing device of claim 10, wherein the functions further comprise:
determining a comparison of the per-group scores between evaluator groups of the plurality of evaluator groups.

12. The computing device of claim 11, wherein providing the at least one score of the one or more per-group scores further comprises providing information about the comparison of the per-group scores.

13. The computing device of claim 11, wherein each evaluation of the one or more surgical skills comprises a score related to at least one surgical skill of the one or more surgical skills, and wherein the per-group scores of the one or more surgical skills of a designated evaluator group of the plurality of evaluator groups comprises a mean value of scores provided by the at least one evaluator of the designated evaluator group.

14. The computing device of claim 13, wherein determining the comparison of the per-group scores comprises determining a comparison of the mean values of scores between evaluator groups of the plurality of evaluator groups.

15. The computing device of claim 10, wherein at least one evaluator group of the plurality of evaluator groups is designated as an expert evaluator group, and wherein each evaluator in the expert evaluator group is designated as an expert about the subject.

16. The computing device of claim 15, wherein at least one evaluator in the expert evaluator group is a surgeon.

17. The computing device of claim 15, wherein at least one evaluator group of the plurality of evaluator groups is designated as an non-expert evaluator group, and wherein each evaluator in the non-expert evaluator group is not designated as an expert about the subject.

18. The computing device of claim 17, wherein providing the at least one score of the one or more per-group scores further comprises comparing the per-group score of the expert evaluator group with the per-group score of the non-expert evaluator group.

19. A non-transitory tangible computer readable medium configured to store at least executable instructions, wherein the executable instructions, when executed by a processor of a computing device, cause the computing device to perform functions comprising:
receiving a request to evaluate media content related to one or more surgical skills and an evaluation form for evaluating the one or more surgical skills;
determining a plurality of evaluator groups to evaluate the one or more surgical skills;
providing the media content and the evaluation form to each evaluator group of the plurality of evaluator groups, wherein each evaluator group comprises one or more evaluators;
receiving evaluations of the one or more surgical skills from at least one evaluator of each of the plurality of evaluator groups, wherein each of the evaluations comprises an at least partially-completed evaluation form;
determining, for each evaluator group of the plurality of evaluator groups, one or more per-group scores of the one or more surgical skills, wherein the one or more per-group scores for a designated evaluation group are based on an analysis of the evaluations of the one or more surgical skills from the evaluators in the designated evaluation group; and
providing at least one score of the one or more per-group scores of the one or more surgical skills.

20. The non-transitory tangible computer readable medium of claim 19, wherein at least one evaluator group of the plurality of evaluator groups is designated as an expert evaluator group, and wherein each evaluator in the expert evaluator group is designated as an expert about the subject.
